(19) United States
(12) Patent Application Publication
(10) Pub. No.: US 2010/0277396 A1
(43) Pub. Date: Nov. 4, 2010

(54) RESTRICTED SPACE SIGNAL DISTRIBUTION NETWORK

(75) Inventors: Allen Ray Gross, Pueblo, CO (US); Phillip Wayne Coiner, Pueblo, CO (US)

Correspondence Address: BANNER & WITCOFF, LTD., 1100 13th STREET, N.W., SUITE 1200, WASHINGTON, DC, 20005-4051, US

(73) Assignee: GPS SOURCE, INC., Pueblo, CO (US)

(21) Appl. No.: 12/750,453

(22) Filed: Mar. 30, 2010

Related U.S. Application Data
(60) Provisional application No. 61/310,088, filed on Mar. 3, 2010.
(60) Provisional application No. 61/164,903, filed on Mar. 30, 2009.

(51) Int. Cl. H01Q 1/00; H01Q 1/12

(52) U.S. Cl. 343/878; 343/905

(57) ABSTRACT

A system providing RF signals to an RF enabled device is described. In some aspects, a connector configured to convey RF signal is provided with a security tether. In other aspects, a connector may be attached to a cradle or display case where the RF enabled device is separately disposed. The connector may provide the RF signal to the RF enabled device via electromagnetic coupling and/or through an external RF antenna coupling.

### CROSS-REFERENCE TO RELATED APPLICATIONS

This application claims priority to U.S. provisional application Ser. Nos. 61/164,903, filed Mar. 30, 2009, and 61/310,088, filed Mar. 3, 2010, whose contents are expressly incorporated herein by reference.

### TECHNICAL FIELD

Aspects of the invention generally relate to electronic devices that rely on radio frequency (RF) signals for their operation.

### RELATED ART

RF-enabled devices often operate poorly in areas where the RF signals are attenuated. Depending on the degree of attenuation, features of the device may become unusable due to the lack of received signals. RF signals may be attenuated for many reasons, such as interference from other signals, geographic features, building design, and construction materials.

Vendors and manufacturers located in areas of high attenuation may desire to provide real or simulated signals to RF-enabled devices for demonstration or testing purposes. However, regulations discourage operation of signal repeaters for certain RF signals, such as GPS signals, in publically accessible spaces.

In the retail setting, vendors may permit customers to take the device to a location where the signals are less attenuated, such as an area outside of a store. However, vendors concerned with theft are often uncomfortable with permitting potential customers to remove unpurchased devices from their premises.

To thwart potential thieves, vendors often tether devices to display cases, shelves, or wall displays with steel cables or other hard-to-cut materials. Vendors also fasten devices to cradles on a display case, shelves, or wall displays.

### SUMMARY

In short, the lack of desired signals for proper demonstration is based not only on regulatory problems concerning transmitting GPS/GNSS signals (current NTIA regulations discourage re-transmission/re-radiating GPS/GNSS signals into publicly accessible spaces) and other RF signals into publicly accessible spaces but also on the physical limitations imposed by building locations, building construction materials and also due to the dynamic nature of signals needed to fully exercise complex devices full capabilities which could interfere with the public's operational devices.

For instance, RF signals are needed to operate RF-enabled devices with embedded GPS receivers, such as auto navigation devices, cell phones and PDAs with E-mail capabilities. As above, merchants, manufacturers and others need to demonstrate their products with live local signals where there is insufficient signal strength or have the ability to switch from live signals to signal scenarios that are unavailable locally or statically. This problem is commonly encountered in retail outlets or other publicly accessibly locations. As such, most vendor displays have security cables or anti-theft tethers on their display cases along with cradles that hold devices. These components in combination with RF distribution components along with the display cases, display shelves and walls provide a means to couple the desired signals and signal scenarios to the devices without the signals interfering with the public's operational devices.

### BRIEF DESCRIPTION OF THE DRAWINGS

FIG. 1 shows an RF-enabled tether in accordance with one or more embodiments.

FIG. 2 shows a radiator implemented as a magnetic coupler integrated into an anchor of a tether in accordance with one or more embodiments.

FIG. 3 shows an RF-enabled device in accordance with one or more embodiments.

FIG. 4 shows a radiator integrated into a tether attached to an RF-enabled device in accordance with one or more embodiments.

FIG. 5 shows a coaxial cable integrated with a tether attached to an RF-enabled device with coaxial antenna connector in accordance with one or more embodiments.

FIG. 6 shows a radiator integrated into a tether attached to an RF-enabled device with coaxial cable for other RF signals in accordance with one or more embodiments.

FIG. 7 shows a radiator integrated into cradle in accordance with one or more embodiments.

FIG. 8 shows a retractable tether with radiator in accordance with one or more embodiments.

FIG. 9 shows a radiator integrated into display case in accordance with one or more embodiments.

FIG. 10 shows a radiator integrated into facade above display case in accordance with one or more embodiments.

FIG. 11 shows a restricted Space RF Signal Distribution Network in accordance with one or more embodiments.

### DETAILED DESCRIPTION

Various connections are set forth between elements in the following description. It is noted that these connections in general and, unless specified otherwise, may be direct or indirect and that this specification is not intended to be limiting in this respect.

In areas where RF signals become attenuated, it may be advantageous to provide less-attenuated signals or simulated signals to RF-enabled devices. Doing so may decrease the likelihood that a device will be unable to receive a signal, thus potentially inhibiting its operation.

Aspects of the disclosure are described with respect to coaxial cables. One can use lossy cables to provide a signal to a device. However, an RF enabled device may function poorly because of smearing of timing signals from the cables. In this regard, lossy cables may be shielded to be used to prevent smearing of timing signals from different portions of signals emanating from various portions of the lossy cables.

A power level of an electromagnetic signal received at an RF enabled device is preferably adjusted to be the same as an RF signal received outdoors (or in an otherwise non-obstructed space). For example, a power level of a GPS signal received at a RF enabled device is generally known as −160 dBW (or equivalently as −130 dBm, ±135 dBW/m2, −105 dBm/m2, −223 dBW/Hz, −163 dBW/MHz, −193 dBm/Hz, −198 dBW/m2/Hz, −138 dBW/m2/MHz).

In some situations, it may be preferable to supply one or more signals from signal generators or simulators to RF-enabled devices. This may be preferable, for example, in a retail setting where the RF-enabled device is a GPS (global positioning system) enabled device, which receives GNSS (global navigational satellite system) signals. In this example, simulated GNSS signals may allow the GPS-enabled device to respond as if it were located at a different location or moving. This would enable potential customers to preview functionality not otherwise available, such as alerts based on a person's location or announcements of upcoming turns. Supplied signals may also be useful in a manufacturing setting. For instance, they may be used to supply a test signal for use in quality control testing of RF-enabled devices.

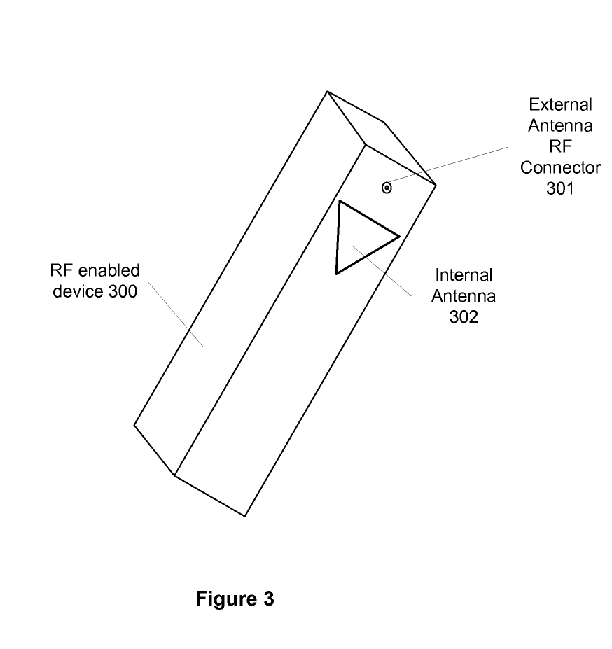

FIG. 3 shows an RF-enabled device 300 with and internal, built-in antenna 302 and an external antenna RF connector 301. For instance, the RF connector 301 may be a coaxial connector. Examples of RF-enabled devices include GPS receivers, cell phones, PDAs, automobile navigation devices, two way radios, satellite phones, satellite radios, wireless e-mail devices, etc. For purposes of explanation, RF-enabled device 300 is shown with both the external antenna RF connector 301 and internal antenna 302. It is appreciated that some RF-enabled devices 300 may only include one of connector 301 or internal antenna 302. Unless specifically described otherwise, aspects of the invention are intended to encompass RF-enabled devices with only internal antenna 302, RF-enabled devices with only an external antenna connected through RF connector 301, and RF-enabled devices with both internal antenna 302 and an external antenna RF connector 301.

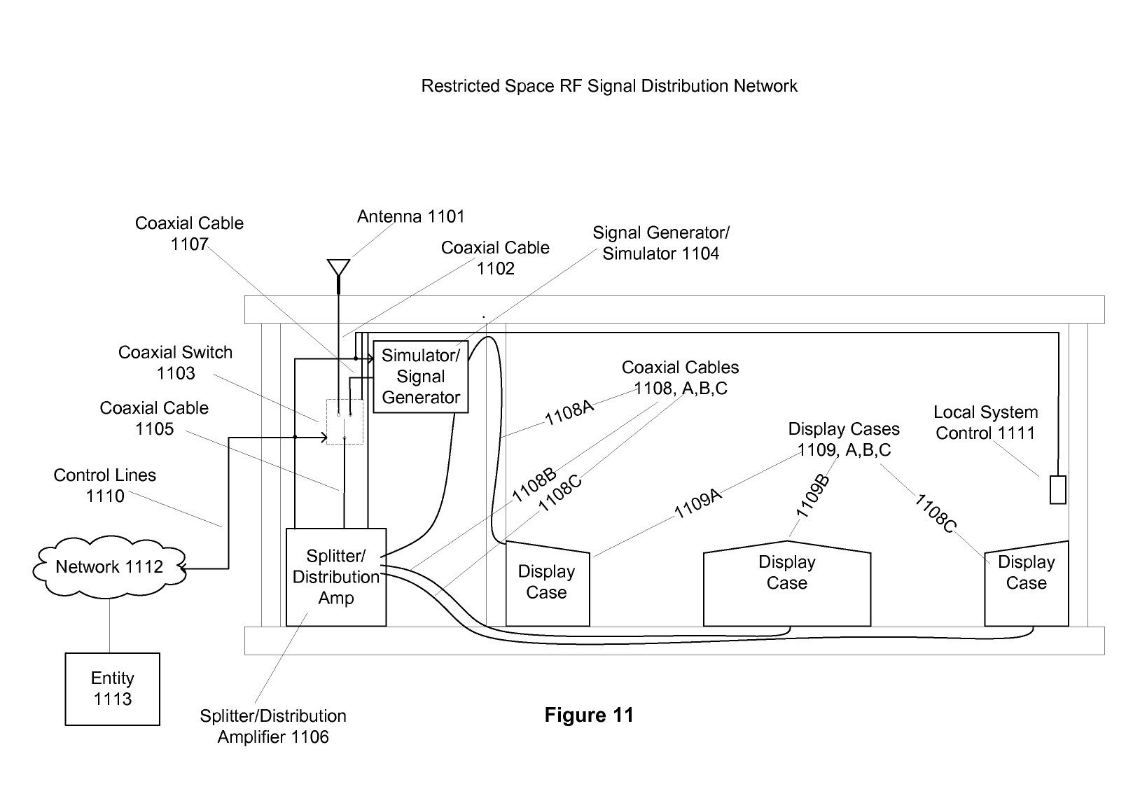

FIG. 11 illustrates an example RF signal distribution network that may support one or more of the features described herein. The RF signal distribution network shown is a coaxial network, but an RF distribution network could be realized by a number of other means, such as with fiber optics, wireless, with waveguides, etc. The RF signals in the distribution network may be in any of the RF bands, such as HF, VHF, UHF, and SHF. The signals may be unidirectional or bidirectional or omnidirectional.

In FIG. 11, antenna 1101 receives one or more signals from the sky and transfers them to coaxial cable 1102. Coaxial cable 1102 transfers the signal to splitter/distribution amplifier 1106. Optionally, the signal may be passed through switch 1103 (shown here as a coaxial switch 1103). Switch 1103 can select between a generated signals carried on coaxial cable 1107 and signals from coaxial cable 1102. The generated signal may be provided by RF signal generator/simulator 1104 to provide a GNSS/GPS signals to coaxial cable 1105. RF signal generator/simulator 1104 and the coaxial switch 1103 and splitter/distribution amplifier 1106 can be controlled via a local control 1111 or remotely via remote entity 1113 connected via network 1112 to select between live signals and simulated/generated signals. It is appreciated that simulator/signal generator 1104 may be located remotely as well (for instance, connected to network 1112). In one example, network 1112 may be the internet. Other networks, public and/or private may be used as well (for instance, a proprietary and secure network of a merchant). The levels of the signals can be monitored and changed as desired. Coaxial cable 1105 transfers the GNSS/GPS signal to Splitter/Distribution Amplifier 1106. Splitter/Distribution Amplifier 1106 supplies the GNSS/GPS signal to the display cases 1109 A, B, C via coaxial cables 1108 A, B, C. While display cases are shown in FIG. 11, coaxial cables 1108 may terminate at other points, such as wall mounts, shelves, floor mounts, points in a ceiling, or a variety of other locations.

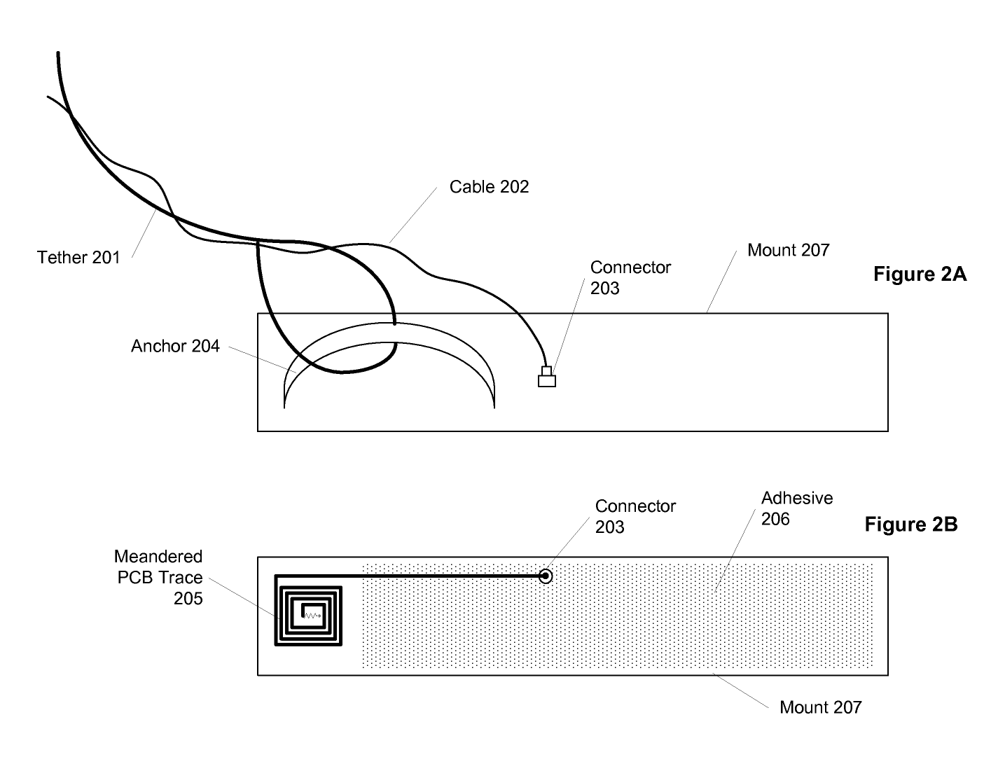

At the display cases or other destinations reached by cables 1108, a number of techniques may be used to transfer signals to RF-enabled devices. The techniques include, but are not limited to, short-range radiators and physical connections. In FIGS. 2A and 2B, an illustrative radiator is implemented as an electromagnetic coupler. The radiator could also be an antenna or other emitter and is not intended to be limited to these devices. In this example, signals from a signal distribution network are transferred to coaxial cable 202 and then to a coaxial connector 203 on mount 207. For instance, the mount 207 may be a printed circuit board (PCB) or other device. The signals are transferred via an internal connection in mount 207 to trace 205. Trace 205 may be exposed wires or other conductors that conduct electromagnetic signals. The RF current in trace 205 generates a magnetic field. When the field is near to an antenna of an RF-enabled device, the field induces an RF current in the antenna corresponding to the RF signal from the signal distribution network. FIG. 2A shows a tether 201 connected to an anchor 204 that is attached or part of mount 207. Cable 202 may be integrated with or wrapped around or juxtaposed (e.g., packaged with in a common casing) tether 201.

FIG. 2B shows a reverse side of mount 207. The reverse side may include an adhesive 206 (for example, cyanoacrylate, epoxy, cement, vinyl adhesive, acrylic solvents, and the like) (or other attachment technique) firmly attach mount 207 to an RF enabled device. The other attachment techniques may include welds, screws, one-way, snap connectors, and the like.

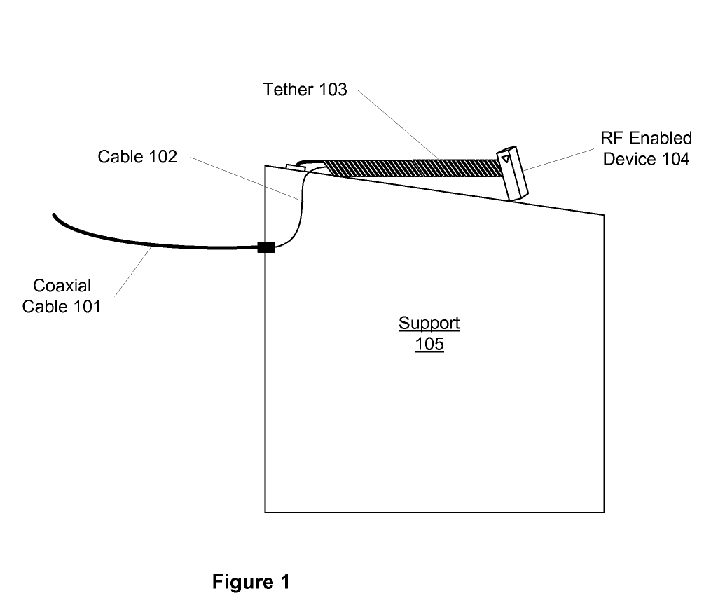

As shown in FIG. 1, a tether 103 may be used to prevent theft in retail or other settings. A coaxial cable 102, or another conductor, may be integrated with tether 103 to transfer signals from an RF signal distribution network, such as the one shown in FIG. 11. The conductor may also or alternatively be wrapped around and/or fastened to the tether. Coaxial cable 102 may optionally connect to a larger coaxial cable 101 (for instance, connected to a back of a support 105) before reaching the rest of the RF signal distribution network. Signals carried in cable 102 may be transferred to RF-enabled device 104 via a radiator, by a direct connection, or both.

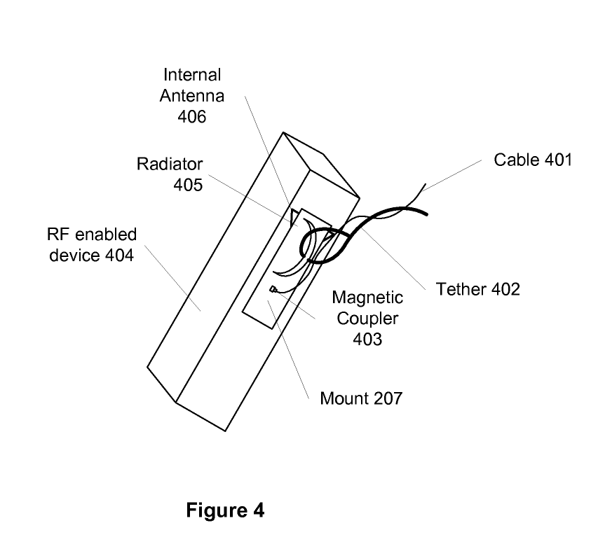

A radiator may be configured as an anchor for the tether, as shown in FIG. 2. In FIG. 4, the mount 207 of FIG. 2 is shown connected to RF-enabled device 404. The radiator 405 of the 207 is placed near the antenna 406 of the RF enabled device, thereby facilitating transfer of RF signals between the antenna and the radiator. Cable 401 is shown with tether 402. Cable 401 is connected to magnetic coupler 403 as attached to mount 207.

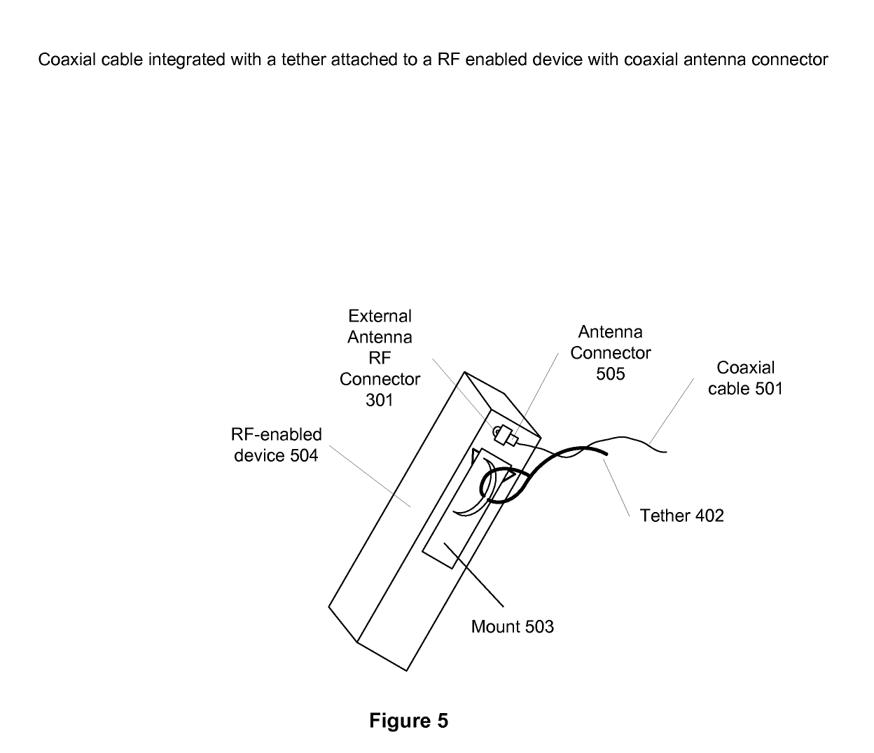

FIG. 5 shows a variation of the anchor of FIG. 4 in which the coaxial cable 501 terminates in a direct connection (external antenna RF connector 301) to RF-enabled device 504 via antenna connector 505. The cable may be connected directly if the RF-enabled device has an available coaxial input connector 301 (for instance). Here, the mount 503 may be separate from antenna connector 505 or may be combined with antenna connector 505 to further enhance the security of mount and prevent tampering.

Variations on the above examples are possible. For instance, two or more conductors may be combined with the security tether. Each conductor may be coupled to a separate RF-enabled device. Alternatively, more than one conductor may be coupled to a single RF-enabled device. As mentioned above, each conductor may be coupled directly or via a radiator, such as an antenna or magnetic coupler. For example, if the RF-enabled device is a cellular phone, cellular signals may be directly connected to a cellular antenna port, while GPS/GNSS signals are radiated to the device's internal

GPS/GNSS antenna. Alternatively, a GPS/GNSS connector may be directly coupled to a GPS/GNSS coaxial connector of the device.

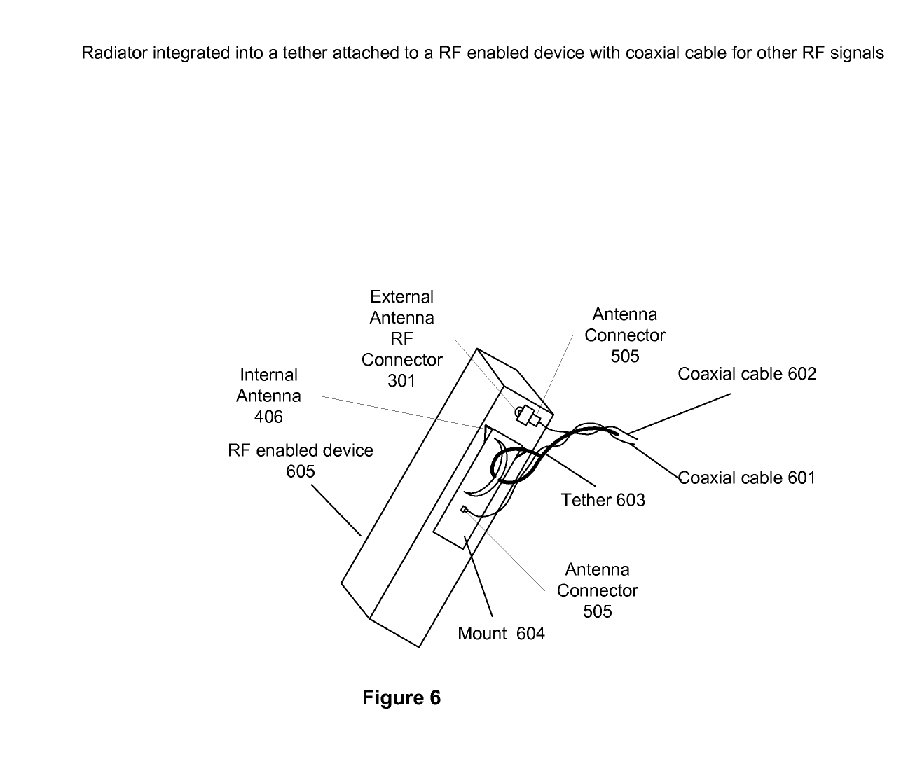

FIG. 6 shows an RF-enabled device 605 with mount 604. FIG. 6 shows two coaxial cables 601 and 602 with tether 603. Coaxial cable 601 is connected to antenna connector 505 and electromagnetically coupled to internal antenna 406 via trace 205 (for example). In addition, coaxial cable 602 is connected to external antenna RF connector 301 via antenna connector 505.

In the example of FIG. 6, tether 603 with coaxial cables 601 and 602 provides a flexible solution to connecting to antennas (406 and 301) whichever is present (or both if desired). For instance, internal antenna 406 may be used for GPS signals while external RF connector 301 may be used for non-GPS signals in a common RF enabled device 605. Alternatively, a merchant may desire to standardize on tether 603 with coaxial cables 601 and 602 instead of using two separate tethers (one with coaxial cable 601 and the other with coaxial cable 602).

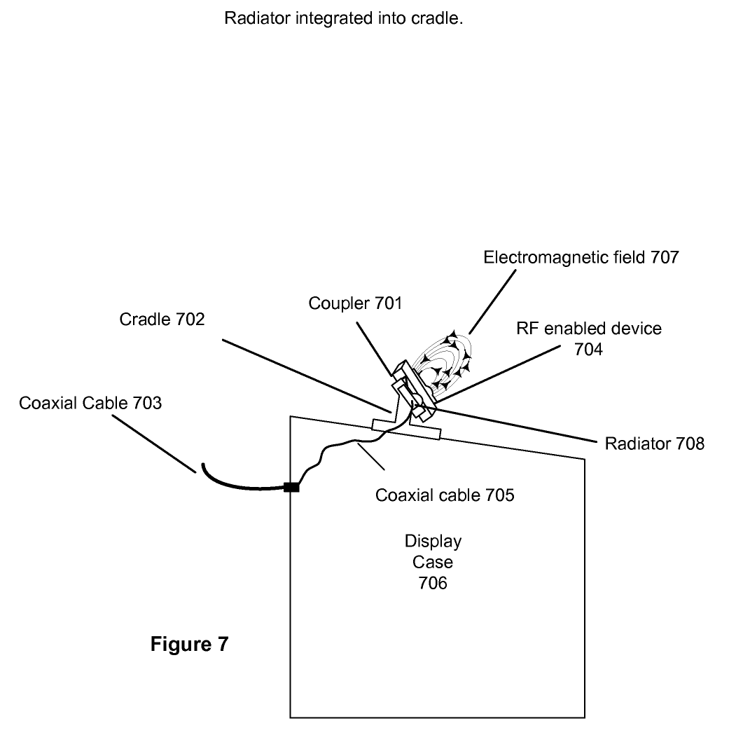

In FIG. 7, an RF-enabled device 704 is shown supported in a cradle 702. The signals from coaxial cable 705 are transmitted via a radiator 708, such as a magnetic coupler 701, that is integrated into the cradle 702. The signals from the radiator are received by the RF enabled device 704. Here, a tether may be also be provided as a security cable but the coupler 701 is attached to (or part of) cradle 702, not a mount attached to the RF enabled device 704.

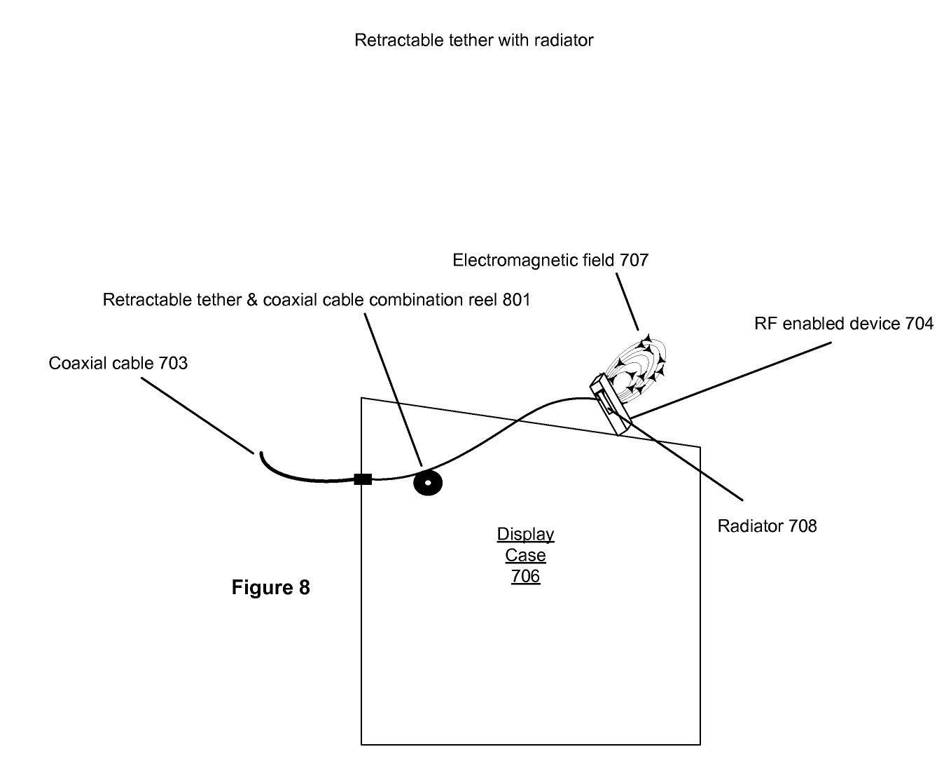

FIG. 8 shows that a tether with an integrated coaxial cable in a retractable combination (for instance, wound around a retractable reel) 801. The combination (or reel) 801 may prevent tangles and reduce excess clutter on display case 706.

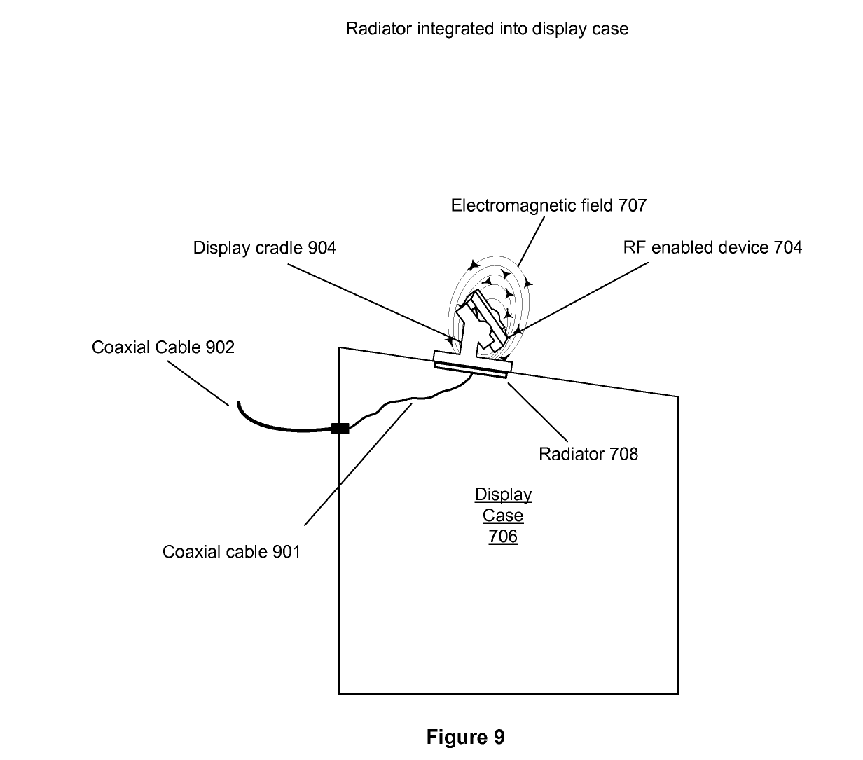

In FIG. 9, a radiator 708 may be located in a display case 706 near one or more RF-enabled devices 704. The RF-enabled devices 704 may be tethered or non-tethered. In one example, the RF enabled device 704 may be fixedly attached to cradle 904. In another example, the RF enabled device 704 may be removable from cradle 904. Electromagnetic field 707 of radiator 708 couples with the antenna of RF-enabled device 903, thus transmitting and receiving signals from cable 901. Cable 901 may also be connected to a larger coaxial cable 902 for connection to a distribution system.

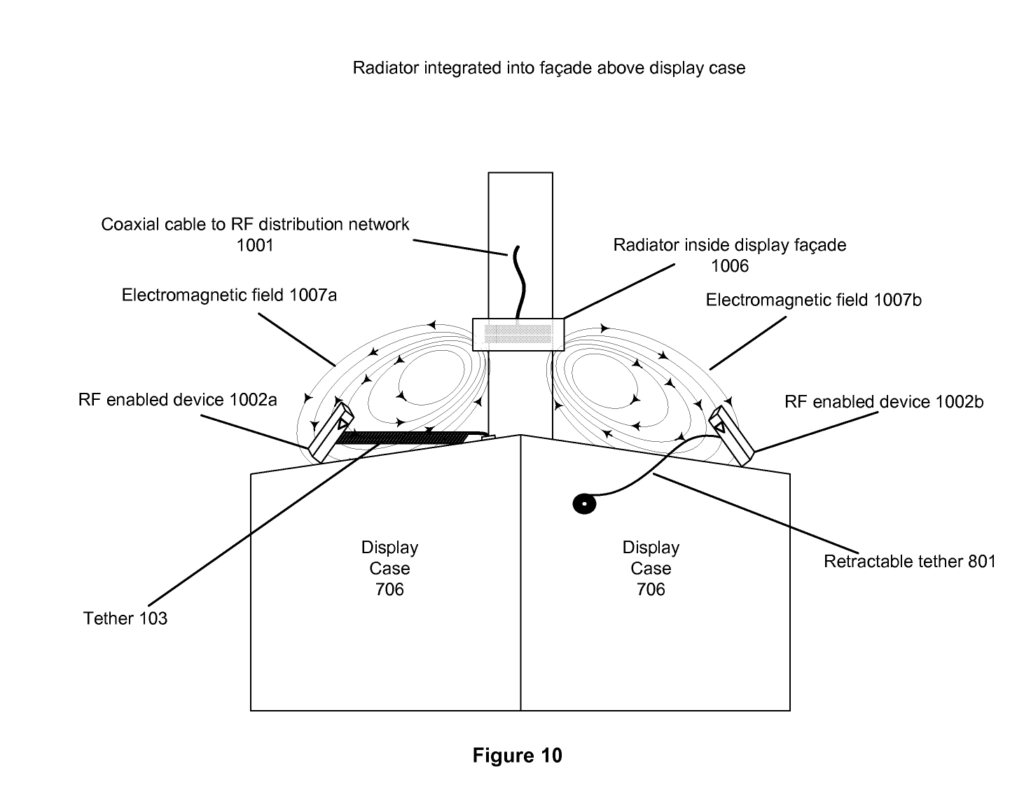

FIG. 10 shows one of the many possible locations in which to place a radiator 1006. In FIG. 10, the radiator 1006 is located in a facade directly above and near a display case 706. The electromagnetic field 1007 (a & b) of the radiator 1006 couples with the antennas of RF-enabled devices 1002 (a & b). In one example, electromagnetic field 1007A and electromagnetic field 1007B have the same signal content. In another example, the fields have different signal content. Having different signal content may be permit users to individually control which signal or signals are received by RF enabled devices 1002A and 1002B. The users may control the signal or signals via control 1111. The power output felt distance r from radiator 1006 may be determined by 1/r² as a free space power computation. In one example, spacing radiators 1006 a large enough distance from each other may permit each RF enabled device 1002A and 1002B to function as intended without being confused from signals from another radiator. Alternatively, radiators 1006 may be unidirectional (or otherwise focused) in their power output to minimize interference with RF enabled devices 1002A and 1002B not directly in front of them.

In one embodiment, the system may allow a user (or employee or signal providing entity or another) to selectively modify the signal or signals emitted from the radiator such that the device 903 locates itself to be at a designated location. For instance, a user may be provided with switch 1111 to modify a signal (or generate a signal) corresponding to a wilderness location, a city location, or any other location so the user is able to more readily appreciate how the RF-enabled device functions (and/or displays information) at that location.

While various coaxial cables are described in the specification and drawings, it is appreciated that other connectors may be used including lossy cables and other known connection devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Numerous other embodiments, modifications and variations within the scope and spirit of the appended claims will occur to persons of ordinary skill in the art from a review of this disclosure.

What is claimed is:

1. A security device comprising:
a tether;
a cable configured to convey RF signals;
a mount having an anchor to which said tether is attached, said mount including a radiator electrically connected to said cable and configured to radiate the RF signals from said cable.

2. The security device according to claim 1, wherein said radiator is a trace on a printed circuit board.

3. The security device according to claim 1, further comprising:
another cable configured to convey other RF signals different from said RF signals,
wherein said another cable includes a connector configured to connect to an external antenna RF connector of an RF enabled device.

4. A security device comprising:
a cable configured to convey RF signals;
a cradle configured to support an RF enabled device, said cradle including a radiator electrically connected to said cable and configured to radiate the RF signals from said cable.

5. The security device according to claim 4, further comprising a tether connectable to said RF enabled device via a second mount.

6. A security device comprising:
a cable configured to convey RF signals;
a cradle configured to support an RF enabled device;
a display including a radiator electrically connected to said cable and configured to radiate the RF signals from said cable, wherein said cradle is attached to said display.
